(19) United States
(12) Patent Application Publication
(10) Pub. No.: US 2009/0248809 A1
(43) Pub. Date: Oct. 1, 2009

(54) Instant Message Session Transfers

(75) Inventors: Aruna Yedavilli, Austin, TX (US); Andrew Dunshea, Austin, TX (US); Suzanne Shi, Austin, TX (US); Jos Manuel Accapadi, Austin, TX (US)

Correspondence Address: LEVEQUE INTELLECTUAL PROPERTY LAW, P.C., 241 E. 4th Street, #102, FREDERICK, MD, 21701, US

(73) Assignee: INTERNATIONAL BUSINESS MACHINES CORPORATION, Armonk, NY (US)

(21) Appl. No.: 12/057,737

(22) Filed: Mar. 28, 2008

(51) Int. Cl. G06F 15/16

(52) U.S. Cl. 709/206

(57) ABSTRACT

A method facilitates instant message (IM) session transfer of messages intended for an IM user to a new IM session being established by the user. Existing IM sessions may be queried for active IM sessions when the user is connecting to an instant message service. If there is an active session for the user, the IM server will request the content and sender of active messages waiting for the user, and transfer this information to the new IM session being established for the user. In this way, the user does not “miss” IM message(s) intended for him or her while going between existing, active IM sessions and new IM sessions. As used herein, session or sessions refer to IM session or IM sessions.

### BACKGROUND

Instant messages and instant messaging provide a powerful tool allowing those engaged in instant message (IM) communications to exchange information quickly and easily. Instant messaging has become so popular as a means of communications, that users commonly engage in IM communications on several systems or places. For example, an IM user may establish an IM session at home, at home, on a personal display device (PDA), while on travel etc. The ability and opportunity to engage in IM communications on various systems and locales is certainly convenient, but it does too often result in a user never receiving or receiving in an untimely manner, instant messages intended to be received quickly and reliably.

Consider, for example, an IM user who routinely establishes IM sessions at home and at work. If such a user establishes an IM session at home and then later at work, it can be seen that a message may be delivered to the home IM session before the work IM session is established and the home IM is disconnected. This results in the user not receiving the message until returning to the original, home IM session, which might be an unacceptable delay of hours or even days. Such delay certainly defeats the ease of use and speed that make IM communications so popular.

Certain options for addressing this concern include the following. Continuing with the home example, a home IM session may be disconnected before leaving for work. This means, however, that the user will not be able to receive messages on either IM accounts from the time the home IM session is disconnected and the work IM session is established. Message queuing is another option in which messages intended for the user are held until the user is back on-line in an established IM session; again, this does not address the issue of remembering to disconnect from a session before becoming unavailable, i.e. before leaving home for the office where a work IM session can be established. Broadcasting of a message to all active sessions associated with the intended recipient is another option. This approach, however, does not address the circumstance in which the user is not actually logged onto the various alternate locations at the point in time that the message is broadcast and meant to be received.

### BRIEF SUMMARY

In accordance with embodiments consistent with the present invention, a method of instant message session transfers is provided. A user initiates a new instant message session through an instant message service. If the instant message service supports simultaneous active instant message sessions for the user and there are a plurality of simultaneous active instant message sessions for the user, then the following may occur: a protocol for an instant message server of the instant message service to transmit session messages of the simultaneous active instant message sessions is determined; the instant message server retrieves the session messages of the simultaneous active instant message sessions; and the instant message server transfers content and sender information of one or more of the session messages of the simultaneous active instant message sessions to the new instant message session of the user in accordance with the protocol. If the instant message service does not support simultaneous active instant message sessions for the user or if there are no simultaneous active instant message sessions of the user, the following may occur: it is determined whether there is an active instant message session of the user; and if there is, the instant message server retrieves a session message of the active instant message session and transfers content and sender information of the session message of the active instant message session to the new instant message session being established and the active instant message session of the user is disconnected in favor of the new instant message session.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a flow of instant message session transfers, including for instant messaging services that accommodate multiple, simultaneous active sessions, in accordance with certain embodiments.

FIG. 2 is a flow of instant message session transfers, in accordance with certain embodiments.

FIG. 3 is a block diagram that illustrates instant message session transfers, including for instant messaging services that accommodate multiple, simultaneous active sessions, in accordance with certain embodiments.

### DETAILED DESCRIPTION

In accordance with embodiments consistent with the present invention, a method a instant message (IM) session transfers comprises the ability to transfer messages intended for an IM user from existing active IM sessions of the user to a new IM session being initiated for the user. Existing IM sessions may be queried for active IM sessions when connecting to an instant message service. If there is an active session for the login identifier (ID) associated with the user, the IM server will request the content and sender of active messages, and transfer this to the new session being established for the user. An active message could be considered all open messaging windows, or perhaps only the last line(s) from active windows for the last known response. In the case of an instant message service being operable to support multiple simultaneous IM sessions for the user, one or more IM messages of multiple active simultaneous IM sessions of the user can be transferred to the new IM session of the user in accordance with a protocol for transferring such messages to the user. In this way, the user does not “miss” IM message(s) intended for him or her while going between existing, active IM sessions and new IM sessions. As used herein, session or sessions refer to IM session or IM sessions.

When an instant message session laid logic request (authenticated request) for a particular user is made and a new IM session established, the IM server can either query to see if this user ID is already logged in, or wait for the next poll request from the it existing clients to determine other active sessions. If or when other active IM sessions are detected by the IM service, the IM service will query these existing logged-in session(s) and request the content, including sender, of active IM message(s) from the existing session. Any active IM messages will be sent to the newly established session. In the instance where polling is used between the user (client) and the IM server, on detection of existing clients, the most recently activated session of the user will be the recipient and all other detected sessions will be queried as found for content.

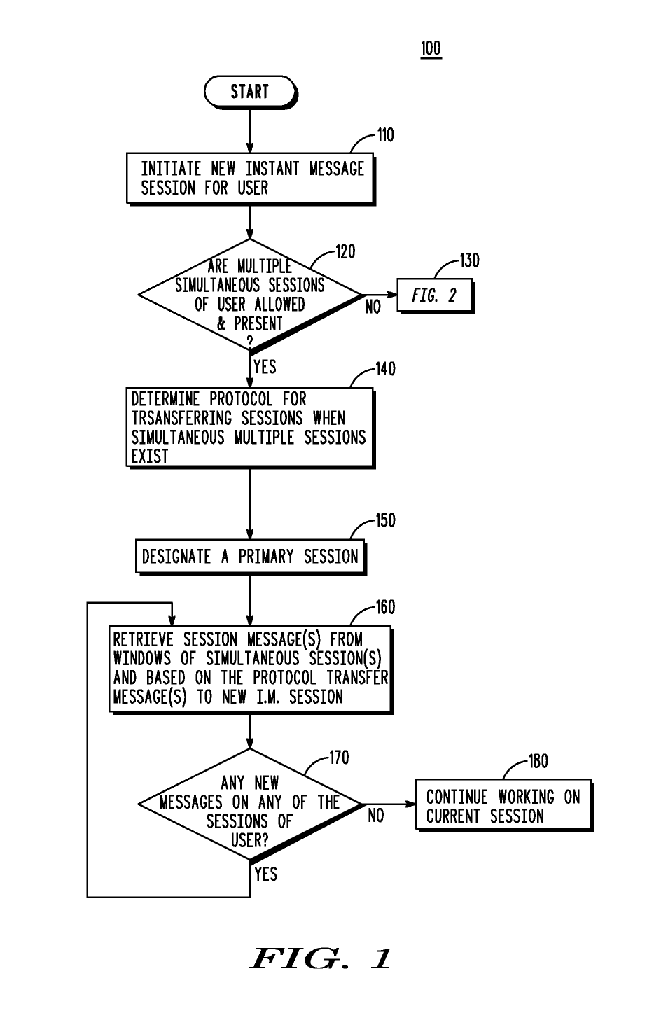

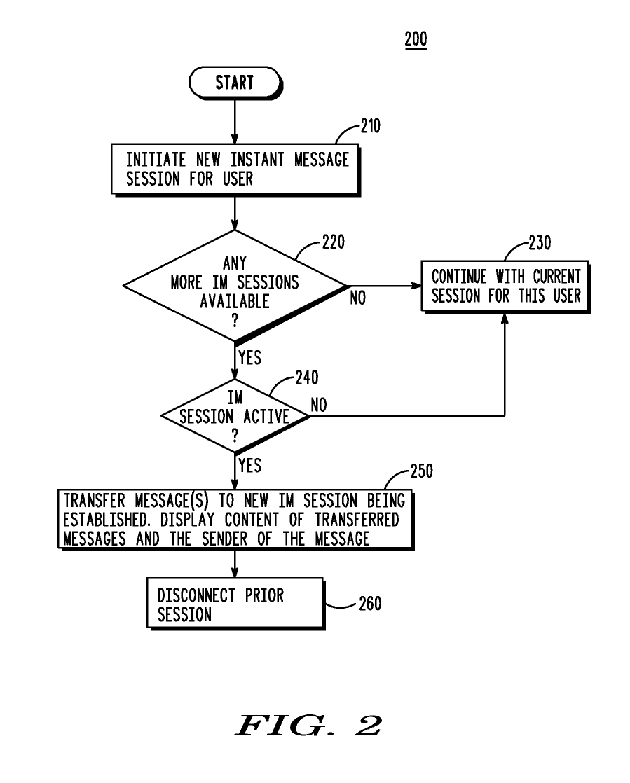

Referring now to the drawings, FIG. 1 illustrates a flow 100 of instant message session transfers, including for instant messaging services that accommodate multiple, simultaneous active sessions, in accordance with certain embodiments. At block 110, a user initiates a new IM session. At Decision Block 120, the query is whether the IM service supports simultaneous active IM sessions for the user and whether any such simultaneous, multiple active IM sessions exist. If no, then instant message session transfer may be accomplished by the flow 200 illustrated in FIG. 2. If yes, then the flow continues to Block 140. A protocol for transferring session message(s) when simultaneous active IM sessions exist is determined. The protocol for transferring session message(s) may reside in the configuration file associated with the user. By way of example and not limitation, the protocol may be to only transfer the last message intended for this user; only transfer up to the last X messages received for this user; or to only transfer message(s) sent to the user at his or her work account. Optionally, at Block 150, a primary session may be designated. This may be the new IM session being established or it may be another IM session associated with the user, such as an IM session established at work, or at home, etc.

Next, at Block 160, session message(s) intended for the user are retrieved from the simultaneous active IM sessions by the IM server and transferred to the user by the IM server in accordance with the protocol. The content and sender information of the one or more session message(s) are transferred in accordance with the protocol. At Decision Block 170, the inquiry is whether there are any new messages on any active sessions of the user. If yes, then the flow returns to Block 160 for disposition. If not, then the new IM session (current IM session) continues according to normal operation. Referring now to FIG. 2, flow 200 of instant message session transfers, in accordance with certain embodiments, is illustrated. This flow covers the conditions where the instant message service does not support simultaneous active instant message sessions for the user or if there are no simultaneous active instant message sessions of the user. At Block 210, a new IM session for the user is initiated. At Decision Block 220, the inquiry is whether there are any more IM sessions available for the user. If no, then the current, newly established IM session continues at Block 230. If yes, then the question, at Decision Block 240, is whether any of the IM sessions are active. If no, then the flow continues to Block 230. If yes, at Block 250, the instant message server retrieves a session message of the identified active instant message session and transfers content and sender information of the IM session message of the active instant message session to the new instant message session being established. The prior session, identified at Block 220, may then be disconnected in favor of the new instant message session at Block 260.

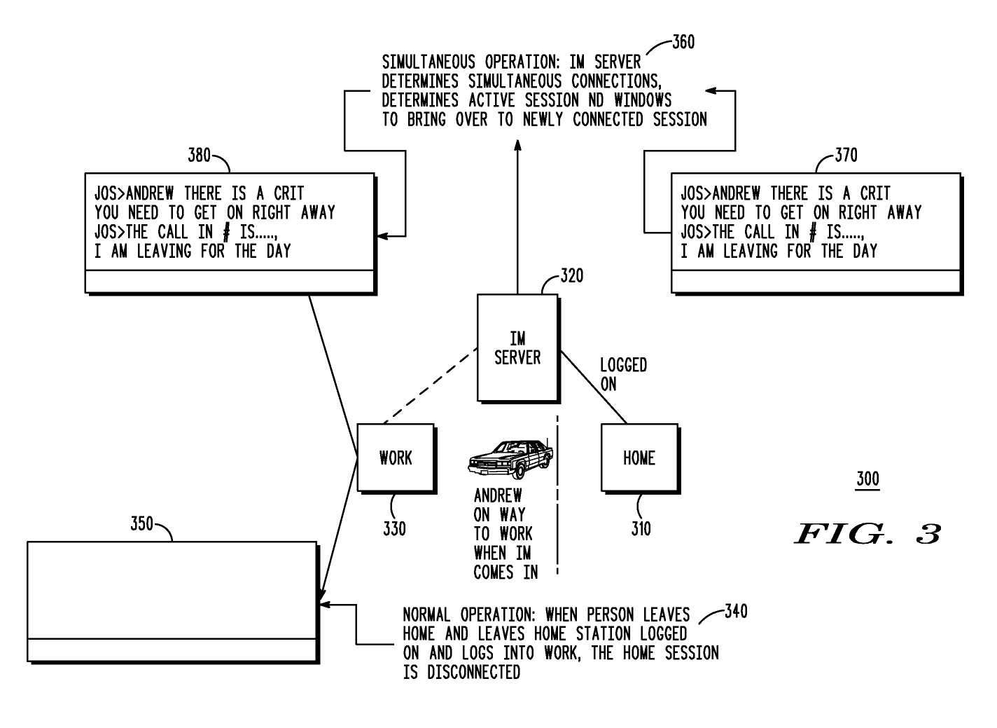

FIG. 3 is a block diagram that illustrates instant message session transfers, including for instant messaging services that accommodate multiple, simultaneous active sessions, in accordance with certain embodiments. This drawing is a further discussion of the circumstance where there may be multiple, simultaneous active IM sessions. For IM services that provide multiple simultaneous IM session, but do not replicate messages, an option can be provided to designate a primary IM session (discussed in connection with FIG. 2 above) and retrieve active message windows having IM messages for a user.

IM server 320 is capable of providing multiple simultaneous sessions, one at Andrew's home 310 and one at Andrew's work 330. In the exemplary embodiment provided, a user, Andrew, is logged into an IM session at home 310. Andrew is on the way to work when an IM for him comes in. In accordance with normal operation (prior art), 340, when a person leaves Home and Leaves his Home station logged on and logs into work, the Home session is disconnected. The IM is not transferred to Andrew and he sees a blank window (with no message) 350 when he logs into work. This is not the case in accordance with certain embodiments described above. In accordance with the simultaneous operation capabilities discussed, the IM server determines simultaneous connections, determines active session(s) and windows (with IM messages) to bring over to the newly connected IM session, 360. This means that the same IM message displayed on window 370 during an IM session at Andrew's home is displayed on the window 380 created Andrew establishes a new IM session at work 330.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of instant message session transfers, comprising:
a user initiating a new instant message session through an instant message service;
if the instant message service supports simultaneous active instant message sessions for the user and there is a plurality of simultaneous active instant message sessions for the user, further:
determining a protocol for an instant message server of the instant message service to transfer session messages of the plurality of simultaneous active instant message sessions to the new instant message session;
the instant message server retrieving the session messages of the plurality of simultaneous active instant message sessions;
the instant message server transferring content and sender information of one or more of the session messages of the plurality of simultaneous active instant message sessions to the new instant message session of the user in accordance with the protocol;
if the instant message service does not support simultaneous active instant message sessions for the user, further:
determining if there is an active instant message session of the user;
if there is an active instant message session of the user, the instant message server retrieving a session message of the active instant message session and transferring content and sender information of the session message of the active instant message session to the new instant message session being established; and
disconnecting the active instant message session of the user in favor of the new instant message session.
